(19) United States
(12) Patent Application Publication
(10) Pub. No.: US 2026/0146846 A1
(43) Pub. Date: May 28, 2026

(54) SYNCHRONOUS MODULATE, GATE AND INTEGRATE 3D SENSOR

(71) Applicant: Nordson Test and Inspection Americas, Inc., Westlake, OH (US)

(72) Inventors: Carl E HAUGAN, St. Paul, MN (US); Timothy A SKUNES, Mahtomedi, MN (US)

(21) Appl. No.: 19/119,887

(22) PCT Filed: Oct. 13, 2023
(86) PCT No.: PCT/US2023/076784

§ 371 Date: Apr. 10, 2025

Related U.S. Application Data
(60) Provisional application No. 63/416,193, filed on Oct. 14, 2022.

(51) Int. Cl. G01B 11/06; G02B 21/24

(52) U.S. Cl. CPC G01B 11/0608; G02B 21/245

(57) ABSTRACT

A confocal three-dimensional sensor (22) for measuring height of a point on an object (10) is provided. The sensor (22) includes a light source (2) and a light source modulator (16) configured to temporally modulate the light source intensity. A source pinhole aperture (4) is positioned to be illuminated by the light source (2) and a focus-tunable lens (8) is configured to focus illumination passing through the source pinhole aperture (4) onto the object (10). A detector pinhole aperture (12) is configured to receive reflected light from the object (10), wherein the focus-tunable lens (8) is configured to image the reflected light from the object (10) onto the detector pinhole aperture (12). A detector (14) and integrator (15) are configured to output a measurement indicative of total light transmitted through the detector pinhole aperture (12). A processor (20) is operably coupled to the detector (14), integrator (15), and light source modulator (16). The processor (20) is configured to synchronously cause the light source modulator (16) to modulate light source intensity while causing the focus tunable lens (8) to sweep axial focal position, the processor (20) being further configured to calculate a height of the point on the object (10) based on the output from the detector (14) and integrator (15).

### CROSS-REFERENCE TO RELATED APPLICATION

The present application is a Section 371 National Stage Application of International patent application Serial No. PCT/US2023/076784, filed Oct. 13, 2023, entitled SYNCHRONOUS MODULATE, GATE AND INTEGRATE 3D SENSOR.

### BACKGROUND

One known technology for 3D optical sensing is triangulation-based phase measurement profilometry. Spatially modulated patterns of light are projected onto an object in triangulation-based phase measurement profilometry and then viewed by an imaging system from a different direction than the projection system. The three-dimensional topography of the object under inspection distorts the projected patterns as viewed by the imaging system and the 3D topography may be calculated by measuring the distortions. Triangulation-based phase measurement profilometry is well suited for high-speed industrial applications since the number of projected patterns, and hence the number of imaging system video frames required is low. Typically, three to twelve patterns and video frames are required for good performance. Triangulation-based systems are not suitable for applications much below lateral resolutions of 2 μm, however, since the required numerical apertures at these resolutions force the size of the projector and imaging systems to expand to the point where they physically interfere with each other. In addition, as the numerical aperture of the optics increases the depth of field of the system decreases, limiting such systems to very small height ranges.

Confocal 3D optical sensing systems are applicable for applications requiring high numerical apertures and lateral resolutions finer than 2 μm since, by definition, the same optical system that illuminates the object also serves to collect the light reflected from the object under inspection. There are many confocal 3D optical sensing technologies including White Light Interferometry (WLI), conventional confocal microscopy, Structured Illumination Microscopy SIM, and chromatic confocal. All of these technologies can deliver high accuracy and large depth of field but suffer from relatively slow speeds which make them unsuitable for many industrial applications.

White Light Interferometry (WLI) axially scans either the object or reference mirror and peak interference at each image pixel is observed when the optical path between the object and reference mirror are equal. One hundred or more axial positions and corresponding video frames are often required to accurately measure the 3D topography of an object making WLI too slow for many industrial applications. Example white light interferometer is disclosed in U.S. Pat. No. 5,706,085.

Conventional 3D confocal microscopes project an array of individual point sources onto an object with a source aperture array, the reflected light is imaged onto a detection aperture array, and the detection aperture array is subsequently imaged onto a camera detector. In some arrangements, the same aperture array can function as both the source and detection aperture arrays. Either the object is mechanically scanned or the focal position is scanned in an axial direction and the peak intensity at each pixel in the camera image is observed when the object is in best focus at that pixel. U.S. Pat. No. 9,041,940 notes that 200 confocal images are conventionally required and the invention of U.S. Pat. No. 9,041,940 claims to reduce that number to 20 images or less.

Structured illumination microscopy (SIM) projects spatially modulated patterns of light onto the object and peak contrast for each point on the object during an axial scan determines best focus and the three-dimensional coordinate at that object point. Techniques to speed up SIM have been developed, but still often require fifty or more axial locations and video frames to accurately measure the 3D topography of an object. Example structured illumination microscopes are disclosed in U.S. Pat. Nos. 8,649,024 and 10,634,487.

Chromatic confocal 3D sensors encode depth through axial chromatic aberration. By measuring the peak spectral value at each pixel, the 3D topography can be accurately measured. Chromatic confocal 3D sensors do not require mechanical axial scanning and can have large depths of field. However, the spectrometer that determines the peak spectral value typically requires sixty four or more pixels for a single point on the object to obtain the required 3D measurement accuracy. Effectively, sixty four or more detector readings are required at each point on an object, again making this technology too slow for many industrial applications. Example chromatic confocal 3D sensor is disclosed in U.S. Pat. No. 9,494,529.

### SUMMARY

A confocal three-dimensional sensor for measuring height of a point on an object is provided. The sensor includes a light source and a light source modulator configured to temporally modulate the light source intensity. A source pinhole aperture is positioned to be illuminated by the light source and a focus-tunable lens is configured to focus illumination passing through the source pinhole aperture onto the object. A detector pinhole aperture is configured to receive reflected light from the object, wherein the focus-tunable lens is configured to image the reflected light from the object onto the detector pinhole aperture. A detector and integrator are configured to output a measurement indicative of total light transmitted through the detector pinhole aperture. A processor is operably coupled to the detector, integrator, and light source modulator. The processor is configured to synchronously cause the light source modulator to modulate light source intensity while causing the focus tunable lens to sweep axial focal position, the processor being further configured to calculate a height of the point on the object based on the output from the detector and integrator.

### BRIEF DESCRIPTION OF THE DRAWINGS

FIG. 1 is a diagrammatic view of an example single point 3D confocal sensor with temporal modulation in accordance with an embodiment disclosed herein.

FIGS. 2A-C show example light source modulator current waveforms.

FIGS. 2D-2F are diagrammatic views of alternate focal sweeps in accordance with one embodiment.

FIGS. 2G-2M are diagrammatic views of alternate focal sweeps in accordance with one embodiment.

FIGS. 3A-3B are flow diagrams of a method of a 3D confocal measurement process in accordance with an embodiment disclosed herein.

FIG. 4 is a diagrammatic view of an example area scan 3D confocal sensor with temporal modulation in accordance with one embodiment.

FIG. 5 is a flow diagram of a method of measuring a surface using a confocal 3D sensor in accordance with an embodiment disclosed herein.

FIG. 6 is a diagrammatic view of an example 3D confocal sensor with temporal modulation in accordance with another embodiment described herein.

FIG. 7 is a diagrammatic view of an example 3D confocal sensor with temporal modulation in accordance with another embodiment described herein.

FIG. 8 is a diagrammatic view of an example 3D confocal sensor with temporal modulation in accordance with another embodiment described herein.

FIGS. 9A-D demonstrate a short coherence length source, such as an LED or incandescent source.

FIG. 9E shows the response of a traditional interferometer when using a longer coherence length source (such as a multi-mode laser).

FIG. 9F is a magnified portion of the scan showing the central portion of FIG. 9E.

FIG. 9G shows a response/scan using a long coherence length source with a 3D confocal sensor in accordance with an embodiment described herein.

FIG. 9H is a magnified portion of the scan showing the central portion of FIG. 9G.

FIG. 10 is a diagrammatic view of an example 3D confocal sensor with temporal modulation utilizing a focus tunable interference objective in accordance with an embodiment described herein.

FIG. 11 is a diagrammatic view of an example 3D confocal sensor with temporal modulation in accordance with another embodiment described herein.

FIG. 12 shows an example SLM spatial pattern that can be used in combination with embodiments described herein.

FIG. 13 is a diagrammatic view of an example 3D confocal sensor with temporal modulation utilizing focus tunable interference objective in accordance with another embodiment described herein.

FIGS. 14A-14F show an example light source modulation phase and frequency pattern for measuring double return.

### DETAILED DESCRIPTION OF ILLUSTRATIVE EMBODIMENTS

Embodiments disclosed herein include improvements to dramatically reduce the number of confocal images required in high accuracy 3D confocal measurement systems, resulting in high speed, high resolution and large depth of field 3D measurements. In contrast with prior art confocal 3D technologies where, for example, fifty or more images are captured in a single focus sweep, the light source of a confocal 3D measurement system is temporally modulated synchronously with a complete focus sweep during a single detector integration period or image capture period. A selected coding scheme determines the number of distinct temporal light source modulation patterns. The modulation patterns are changed between subsequent image captures and focus sweeps. The resulting image intensities from each modulation pattern and focus sweep may then be used to decode the peak focus position for every pixel in an image. For sinusoidally varying temporal modulation patterns, the phase of the light source is changed between subsequent image captures and the peak focus position for every pixel in the image is computed using standard spatial phase shift algorithms. In this manner, embodiments can synchronously modulate, gate and integrate. The light source and focus can be synchronously modulated. Pinhole apertures are the gates that only allow light from best focus to transmit through. The detector can integrate during an entire modulation of the light source and focus sweep.

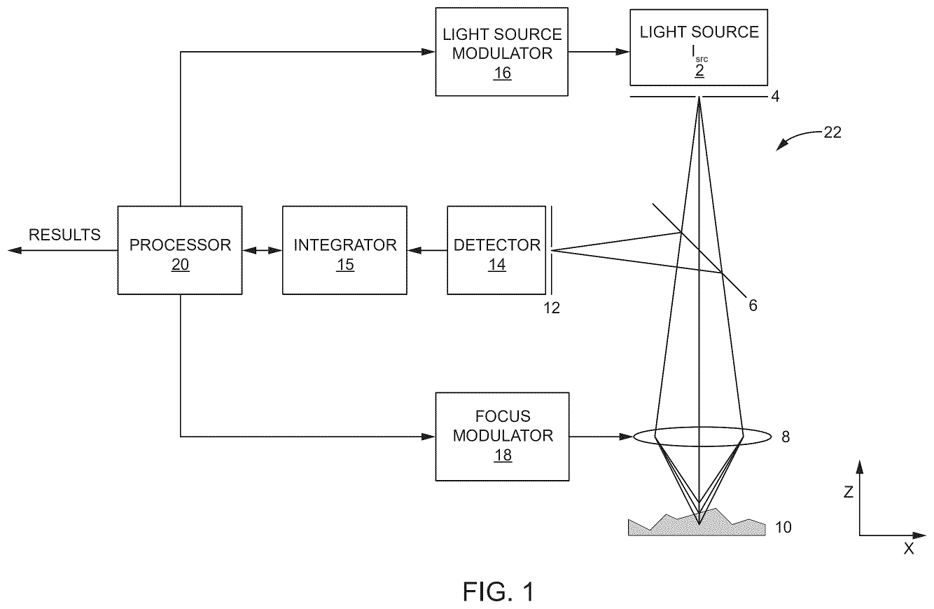

FIG. 1 is a diagrammatic view of an example single point 3D confocal sensor 22 with temporal modulation. Light from source 2 illuminates source pinhole aperture 4, transmits through beam splitter 6 and is converged towards object under test 10 by focus tunable lens 8. Light then reflects from object 10, passes back through focus tunable lens 8, is reflected by beam splitter 6, and converges towards detection pinhole aperture 12. Light passing through detection pinhole 12 is collected by detector 14 and integrator 15. Due to the optical sectioning properties of confocal microscope systems, light transmitting through detection pinhole 12 will be maximized when the transmitted light from pinhole aperture 4 is at best focus on object 10. Away from best focus, most of the light reflected from object 10 will be blocked by detection pinhole 12. The optical sectioning properties of confocal microscopes is also described in the literature as “confocal gating”. The source and detection pinhole apertures create a “gate” that essentially allows only light from the best focus location to transmit through the detection pinhole aperture.

Light source 2 may be, but is not limited to, a LED, laser (such as a solid state laser), or incandescent source whereby the output intensity may be temporally modulated by light source modulator 16. Focus tunable lens 8 may be, but is not limited to, a lens mechanically scanned by a voice coil or linear stage. Alternatively, focus tunable lens 8 may be a liquid lens where focus is adjusted by electrostatically changing the curvature of a liquid lens surface or by using sound waves to change the refractive index of focus tunable lens 8.

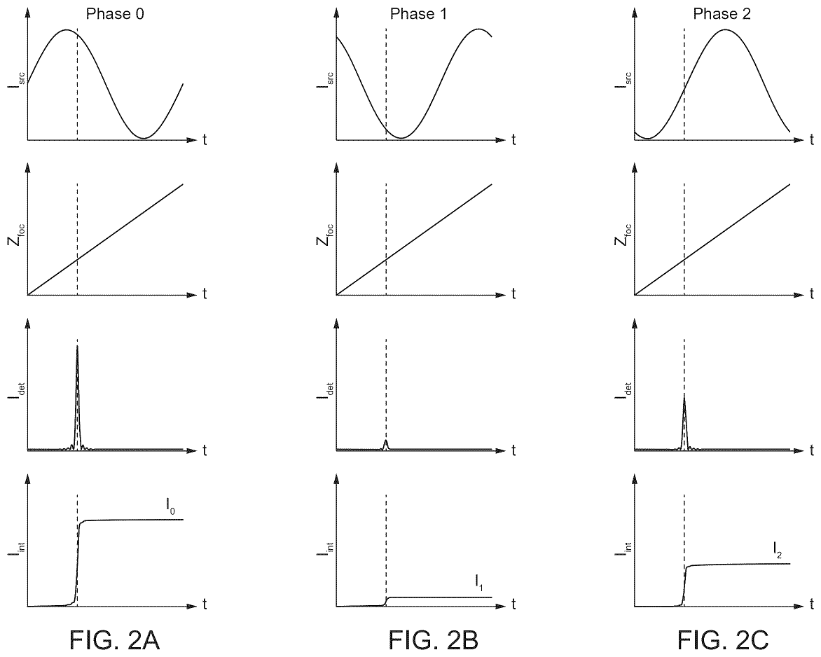

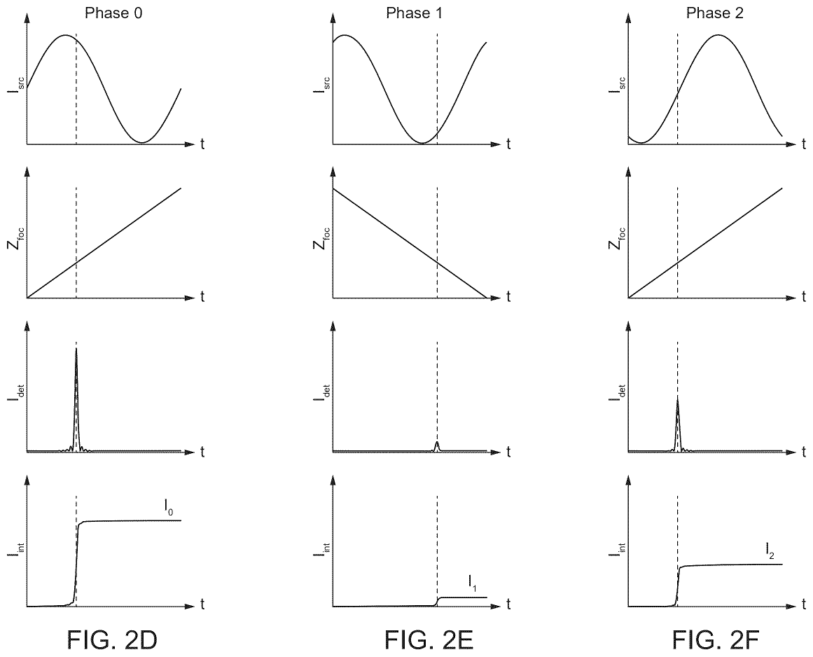

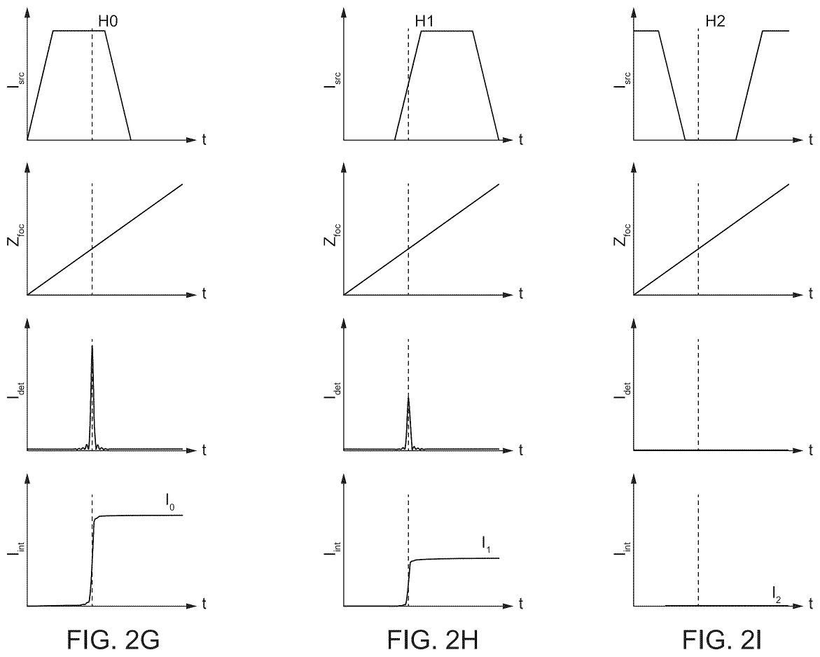

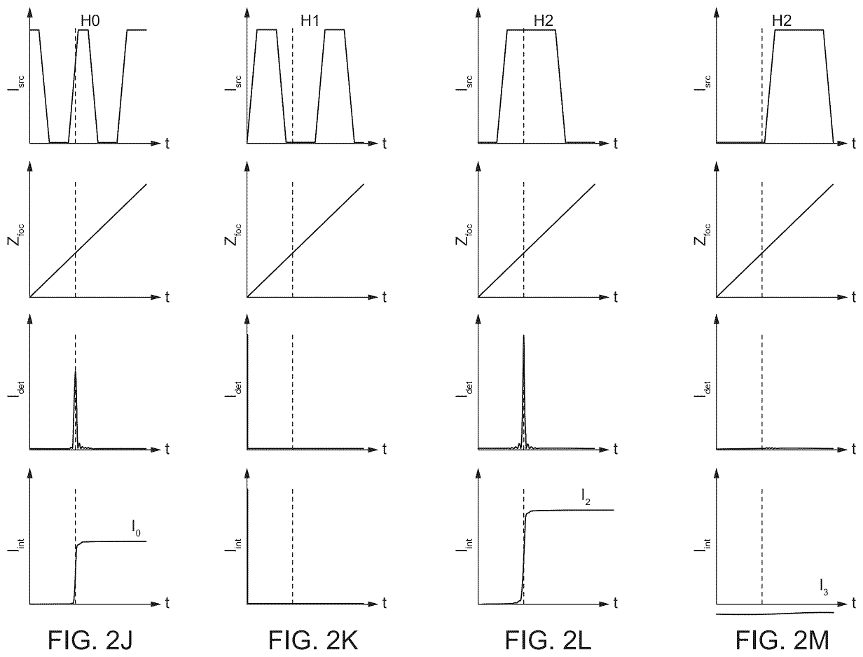

FIGS. 2A-C show example light source modulator 16 current waveforms I_{src} for single frequency sinusoidal modulation patterns. I_{src} is sinusoidally modulated at frequency fₖ according to equation 1a, where n=0, 1, 2, t is time, and Iₚₑₐₖ is the peak LED current. The value for peak LED current Iₚₑₐₖ is selected to provide suitable illumination levels for the object being inspected.

$${I}_{srs , 0} = \frac{{I}_{peak}}{2} ( 1 + sin ( 2 π {f}_{k} t + \frac{n 2 π}{3} ) ) \qquad \text{?}$$

$$\text{?} \text{indicates text missing or illegible when filed}$$

Focus modulator 18 is also synchronized with light source modulator 16 to sweep focus position Z_{foc} of tunable lens 8 as shown in FIGS. 2A-C. In the example of FIG. 2A, there is a peak in the detected current I_{det}, proportional to I_{src,0}, by detector 14 at the Z_{foc} location indicated by the vertical dashed lines. This detected current is integrated by integrator 15 to record a level I₀. This return is visible in the integrated signal Iᵢₙₜ. In other words, the position of best focus is encoded by the phase of sinusoidal waveform I_{src} as the focus position is being swept synchronously with the light source modulator 16.

In FIG. 2B, the phase of light source modulator 16 is shifted by 2π/3 radians, corresponding to n=1 in Equation 1. Peak detected current I_{det} is again at best focus and is proportional to I_{src,1} resulting in an integrated value I₁. In FIG. 2C, the phase of light source modulator 16 is shifted by 4π/3 radians, corresponding to n=2 in Equation 1. Peak detected current I_{det} is again at best focus and is proportional to I_{src,2}, resulting in an integrated value I₂. To solve for the phase of I_{src}, and hence the position of best focus, standard phase shift techniques from interferometry or phase shift profilometry may be used such as the technique known as three phase reconstruction. From standard phase shift algorithms, the phase Φ, which encodes the position of best focus is given by Equation 2. The inverse tangent function in Equation 2 returns values between −π/2 and π/2, the signs of the numerator and denominator of the equation may be used to map this phase to a 0 to 2π range. Once phase is adjusted to the 0 to 2π range the time t associated with that phase can be calculated using Equation 10. The reflectance, R, of object 10 at the measurement point is given by Equation 3 and is directly proportional to the sum of the three detected peak currents with a scaling factor α. The contrast of the received signal, C, is given by equation 4. Contrast is distinct from reflectivity (defined in equation 3), reflectivity measures all light received while contrast is a measure of the strength of the detected sine wave.

$$ϕ = {tan}^{- 1} [ \frac{2 {I}_{0} - {I}_{1} - {I}_{2}}{\sqrt{3} ( {I}_{1} - {I}_{2} )} ] \qquad Equation 2$$

$$R = α \times \frac{{I}_{0} + {I}_{1} + {I}_{2}}{3} \qquad Equation 3$$

$$C = \frac{2}{3} ( {I}_{0}^{2} + {I}_{1}^{2} + {I}_{2}^{2} - {I}_{0} {I}_{1} - {I}_{0} {I}_{2} - {I}_{1} {I}_{2} ) \qquad Equation 4$$

$$t = \frac{ϕ}{2 π {f}_{k}} \qquad Equation 10$$

Other phase shift techniques may be used such as the four phase technique which uses four sinusoidal light source modulations I_{src},n, n=0, 1, 2, 3 and the phase is shifted by π/2 radians each time n is incremented by 1. Additionally, higher frequency sinusoidal waveforms I_{src} which would go through several periods as the focus is swept may be used to increase the sensitivity of the phase detection. This creates the so-called 2π ambiguity problem which can handled by using multiple sinusoidal waveforms I_{src} frequencies and phases. For example, two different frequencies can be used to create a longer synthetic wavelength and eliminate the 2π ambiguity.

The wavelength for frequency fₖ is given by equation 5 where v_{z} is the velocity of the focus position change; in MKS units, if v_{z} is in m/s and fₖ is in cycles/s then λₖ will be in m/cycle.

$${λ}_{k} = \frac{{v}_{z}}{{f}_{k}} \qquad Equation 5$$

A synthetically longer wavelength λ_{syn} may be created with wavelengths λ₁ and λ₂ by equation 6.

$${λ}_{syn} = \frac{{λ}_{1} * {λ}_{2}}{{λ}_{1} - {λ}_{2}} \qquad Equation 6$$

If two or more frequencies are used then the closed form solutions for phase and contrast, Equations 3 and 4, no longer apply. Since the integrated light level model includes trigonometric functions the most straightforward method estimating the object characteristics is an iterative least squares solver. A number of math libraries offer tools to minimize the fitting residual defined in equations such as eq. 8, for instance Matlab® (version 2022b, The Math Works Inc.) includes the function fminsearch. Minimizing the fitting residual begins by defining the fitting residual in equation 8.

$${r}_{k , n} = {I}_{k , n} - {\hat{I}}_{k , n} \qquad Equation 8$$

Where I_{k,n} are the measured image levels for each phase n and frequency k and Î_{k,n} is the estimated image level for an estimated reflectivity, phase, and contrast.

$${\hat{I}}_{k , n} = \frac{\hat{R}}{2} ( 1 + {\hat{C}}_{0} sin ( 2 π {f}_{k} {\hat{t}}_{0} + \frac{n 2 π}{3} ) ) \qquad Equation 1 b$$

Equation 1b models the integrated returned intensity. The modeled integrated returned intensity is identified as Î_{k,n}, this is distinct from the measured integrated value Iₙ. In Equation 1b \hat{R} is the estimated reflectivity of the object, including detector dark level and ambient light reaching the detector. Estimated signal contrast is modeled as Ĉ₀. The estimated position of the object surface is identified by \hat{t}₀, the time point when the focus plane sweep crossed the object surface.

The typical approach is to minimize the sum of squared residuals, calculated as S in Equation 9.

$$S = \sum {r}_{k , n}^{2} = \sum {( {I}_{k , n} - {\hat{I}}_{k , n} )}^{2} \qquad Equation 9$$

Supplying this residual function along with initial parameter estimates to the iterative least squares solver results in best fit estimates for \hat{R}, Ĉ, and \hat{t}₀.

FIGS. 2A-2C show a linear sweep of focus position Z_{foc}. A calibration process, not shown, may accurately characterize any non-linearities of focus position Z_{foc} as well as the precise range of the focus sweep.

Other temporal light source modulation techniques that encode the location of best focus during the focus sweep may include, but are not limited to, Gray codes, linearly ascending and descending ramps, and Hamiltonian codes. Example measurement coding scheme with three Hamiltonian light source modulation patterns is shown in FIGS. 2G-21 and example measurement coding scheme with four Hamiltonian light source modulation patterns is shown in FIGS. 2J-2M.

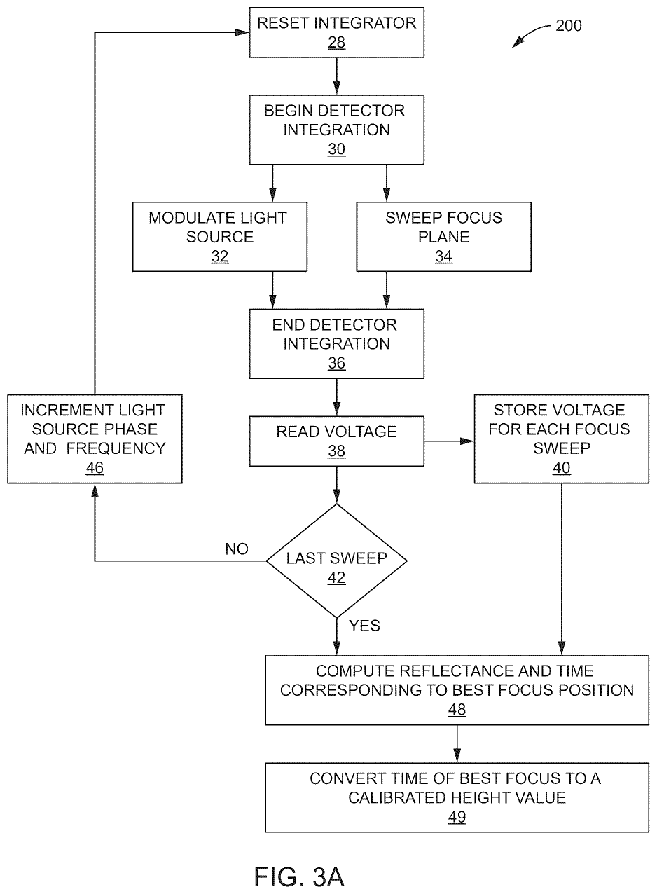

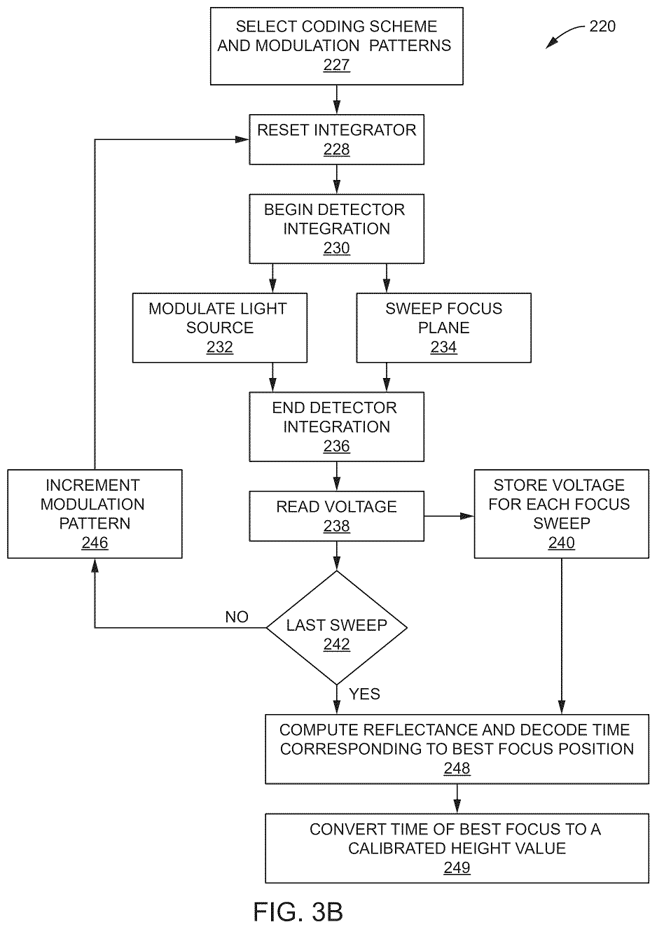

FIG. 3A is a flow diagram of a method of a 3D confocal measurement process with phase measurement coding scheme and sinusoidal modulation patterns in accordance with an embodiment disclosed here. FIG. 3A further illustrates the measurement process of confocal 3D sensor 22. The process begins by processor 20 resetting integrator 15 at step 28. The process proceeds to step 30 where current from detector 14 begins to be integrated by integrator 15. Immediately after step 30, processor 20 signals light source modulator 16 to sinusoidally modulate light source 2 at an initial phase and frequency at step 32 while processor 20 also signals focus modulator 18 to synchronously begin sweeping the focus plane at step 34 as is shown in FIG. 2A, for example. When the focus sweep is complete and light source has gone through a predetermined number of cycles, processor 20 signals integrator 15 to stop integration at step 36 and then the integrated current from detector is read out as a voltage at step 38 by processor 20. The voltage for each focus sweep is stored by processor 20 at step 40 while proceeding to decision block 42. It is determined at block 42 if the last phase is complete. If it is not the last sweep, then processor 20 increments the phase, and the next frequency if applicable, at step 46. Processor 20 then resets integrator 15 at step 28 and signals detector 14 integration to begin as well as signaling light source modulator with the next phase and next frequency, if applicable. The process then repeats until processor 20 determines the last sweep is complete at step 42. The stored voltages corresponding the phase of best focus for each focus sweep are retrieved at step 48 and processor 20 computes the phase of light source I_{src} corresponding the position of best focus at step 48 using standard phase shift techniques such as equation 2. The time corresponding to the position of focus may then be calculated using Equation 10, for example. Reflectance at the measurement location is calculated using equation 3 and contrast may be calculated using equation 4, for example. At step 49, the time of best focus is converted to a calibrated height value by processor 20 accounting for the precise range of focus sweep and any non-linearities of the focus sweep.

The measurement process may be sped up by alternating the direction of focus sweep between each integration period to take advantage of the focus retrace. Referring to FIGS. 2D-2F, the focus position Z_{foc} is swept from low to high in FIG. 2D. The sweep direction of Z_{foc} in FIG. 2E is swept from high to low and swept from low to high in FIG. 2F. To accommodate the polarity change of the sweep direction, the phase of I_{src},1 is time reversed in FIG. 2E relative to I_{src},1 in FIG. 2B. Equation 2 may then be used to calculate the phase, Φ, which encodes the position of best focus. Equation 3 is also used to calculate the reflectance at the measurement location.

FIG. 3B is a flow diagram of a method of a 3D confocal measurement process with selectable coding patterns in accordance with an embodiment disclosed here. FIG. 3B further illustrates the measurement process of confocal 3D sensor 22. Process 220 begins by selecting an appropriate coding scheme and light source modulation patterns at step 227 such as the coding scheme of FIGS. 2J-M with four Hamiltonian light source patterns. Processor 20 then resets integrator 15 at step 228. The process proceeds to step 230 where current from detector 14 begins to be integrated by integrator 15. Immediately after step 230, processor 20 signals light source modulator 16 to modulate light source 2 at step 232 in accordance an initial modulation pattern, in accordance with the selected coding scheme, while processor 20 also signals focus modulator 18 to synchronously begin sweeping the focus plane at step 234 as is shown in FIG. 2J, for example. When the focus sweep and modulation pattern are complete, processor 20 signals integrator 15 to stop integration at step 236 and then the integrated current from detector is read out as a voltage at step 238 by processor 20. The voltage for each focus sweep is stored by processor 20 at step 240 while proceeding to decision block 242. It is determined at block 242 if the last modulation pattern is complete. If it is not the last sweep, then processor 20 increments the modulation pattern at step 246. Processor 20 then resets integrator 15 at step 228 and signals detector 14 integration to begin as well as signaling light source modulator with the modulation pattern. The process then repeats until processor 20 determines the last sweep is complete at step 242. The stored voltages corresponding the time of best focus for each focus sweep are retrieved at step 248 and processor 20 decodes the time corresponding the position of best focus at step 248 in accordance with the selected coding scheme. Reflectance is also calculated at step 248. At step 249, the time of best focus is converted to a calibrated height value by processor 20 accounting for the precise range of focus sweep and any non-linearities of the focus sweep.

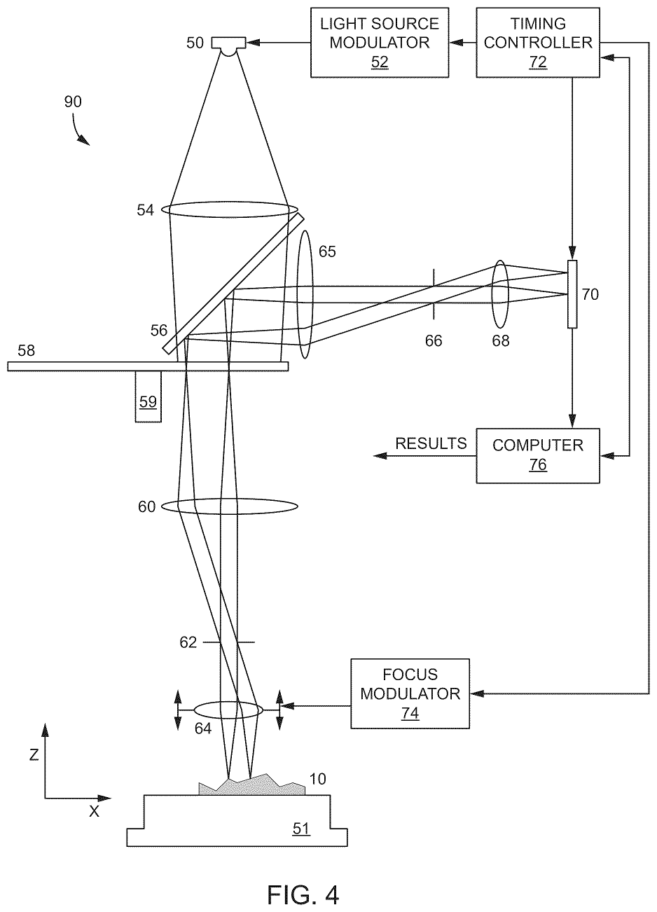

FIG. 4 is a diagrammatic view of an example area scan 3D confocal sensor 90 with temporal modulation. Light from source 50 is modulated by light source modulator 52, collected by condenser lens 54, transmitted through beam splitter 56 and projected onto Nipkow disk 58. Nipkow disk 58 contains an array of pinhole apertures and is rotated by motor 59. An example Nipkow disk is disclosed in U.S. Pat. No. 4,927,254. Lens 60, aperture stop 62 and focus tunable lens 64 create an imaging system to image Nipkow disk 58 pinhole apertures onto object 10. Light reflected from object 10 is imaged back onto Nipkow disk 58 by lens 64, aperture stop 62 and lens 60. Reflected light passing through Nipkow disk 58 apertures reflects off beam splitter 56 and is imaged onto camera detector 70 by the imaging system formed by lens 65, aperture stop 66 and lens 68. Again, due to the optical sectioning properties of confocal microscopes, reflected light transmitted through Nipkow disk 58 pinhole apertures will have a peak intensity when the point on the object is in best focus and the intensity will decrease rapidly away from best focus. Camera detector 70 may be, but is not limited to, a CMOS or CCD area array with a two-dimensional array of pixels. Focus tunable lens 64 may be, but is not limited to, a lens mechanically scanned by a voice coil or linear stage. Alternatively, focus tunable lens 64 may be a liquid lens where focus is adjusted by electrostatically changing the curvature of a liquid lens surface or by using sound waves to change the refractive index of focus tunable lens 64. Light source 50 may be, but is not limited to, a LED, solid state laser, or incandescent source whereby the output intensity may be temporally modulated by light source modulator 52.

Object 10 is conveyed by stage assembly 51. Stage assembly 51 may include one or more linear or rotary stages.

Timing controller 72 signals the temporal modulation pattern for each focus sweep to light source modulator 52. Timing controller 72 also synchronizes the timing of light source modulator 52 and focus modulator 74 to sweep the focus while simultaneously temporally modulating light source 50 during one integration period of camera detector 70.

Nipkow disk 58 may be designed with pinhole patterns along Archimedean spirals, the pattern may consist of a single continuous spiral or of multiple interleaved spirals. If a single spiral is used, then the disk must spin an entire revolution to sample all radial distances. If there are N spirals, then the disk must spin 1/N revolutions to sample all radial distances. Because the focus sweep results in only a brief period of being near best focus (when maximum light levels are returned to the detector), the pinhole pattern may be designed to sample all necessary radial positions over a small rotation angle. This can be accomplished by utilizing a very large number of spirals and by staggering the radius of the pinholes in each spiral to maximize the radial coverage over short rotation angles. The geometric shape of the pinhole apertures may be, but are not limited to circular, square, or octagon shapes. The geometric shape of the pinhole apertures may also thin straight or curved lines. In another embodiment, rotating Nipkow disk 58 may be replaced by an array of pinhole apertures that are linearly translated. The design of the aperture patterns may be optimized to balance light throughput, axial resolution, and cross-talk from out of focus regions passing through adjacent apertures. The cross-talk contributes to background intensity I_{det} away from the location of best focus.

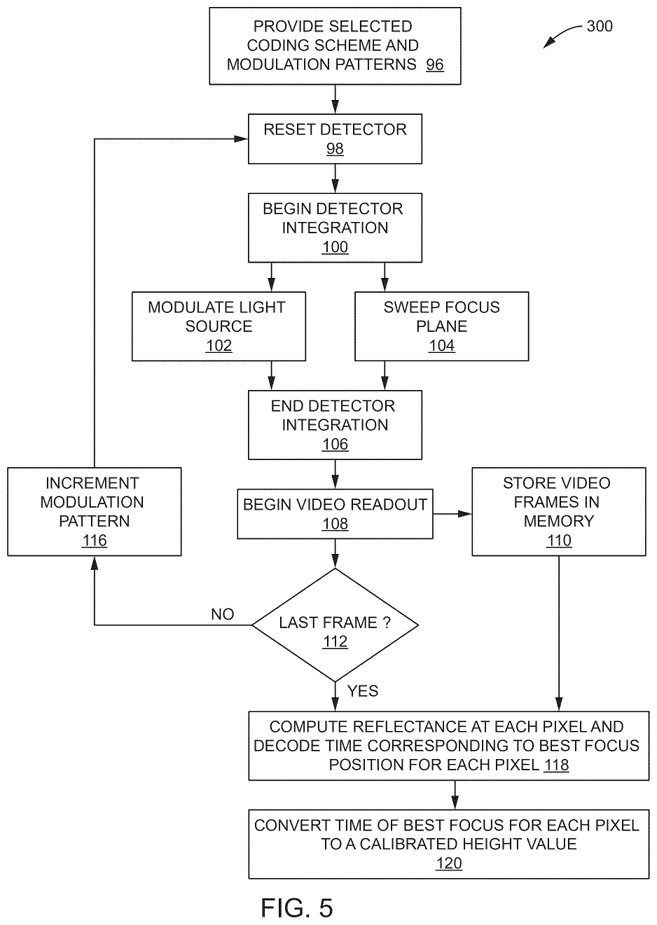

FIG. 5 is a flow diagram of a method of measuring a surface using a confocal 3D sensor in accordance with embodiments disclosed herein. Method 300 begins in step 96 by computer 76 providing selected coding scheme and light source modulation patterns to timing controller 72 such as the coding scheme of FIGS. 2G-21 with three Hamiltonian light source modulation patterns. Next, camera detector 70 is reset by timing controller 72 at step 98. Method 300 proceeds to step 100 where the integration begins for a single video frame of detector 70. Immediately following step 100, timing controller 72 signals light source modulator 52 to modulate light source 50 with an initial modulation pattern at step 102 while timing controller 72 also signals focus modulator 74 to synchronously begin sweeping the focus plane at step 104 as is shown in FIG. 2G, for example. When the focus sweep is complete and light source modulator 52 has completed the modulation pattern, timing controller 72 signals detector 70 to stop integration at step 106. Readout of video data begins at step 108 and is transferred to memory in computer 76 at step 110. The process proceeds to decision block 112 where it is determined by timing controller if the last modulation pattern is complete. If it is not the last sweep, then timing controller 72 increments the modulation pattern at step 116. Detector 70 is then reset at step 98 and timing controller 72 then signals camera detector 70 to begin the integration of the next video frame at step 100. Method 300 then repeats until timing controller 72 determines the last sweep is complete at step 112. Stored pixel values of the corresponding time of best focus for each focus sweep are retrieved at step 118 and computer 76 decodes the time of light source I_{src} corresponding to the time of best focus at step 118 for all pixels of camera detector 70. Reflectance for all pixels is also calculated at step 118. At step 120, the time of best focus for each pixel is converted to a calibrated height value for each pixel by computer 76 accounting for the precise range of focus sweep and any non-linearities of the focus sweep or optical aberrations. The calibration process of 3D confocal sensor 90 may also accommodate for other design and manufacturing tolerances such as field curvature across the field of view of camera detector 70. At this point, computer 76 may command stage assembly 51 to translate object 10 to a new location and begin another measurement cycle at a different field of view.

In another example, detector 70 may also be a line scan detector which is configured as a one-dimensional array of photodetectors or pixels, or a Time Delay and Integration (TDI) image sensor, each of which creates a line field of view. In this example, stage assembly 51 may move continuously during detector 70 integration in a direction perpendicular to the line field of view. The velocity of stage assembly 51, the integration time of detector 70 and the number of focal sweeps per measurement then affect the lateral resolution in the direction of stage movement.

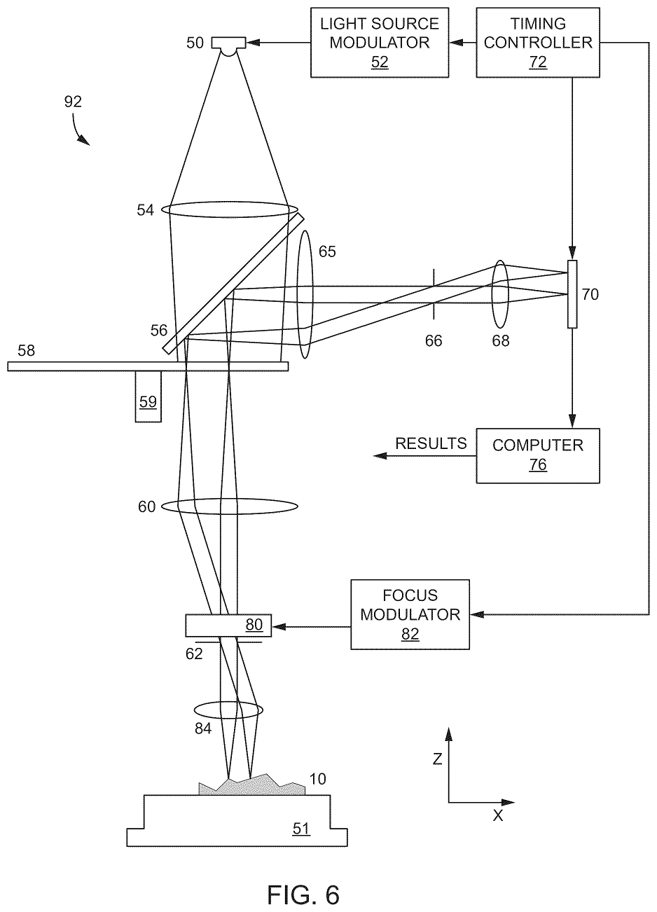

FIG. 6 is a diagrammatic view of an example 3D confocal sensor 92 with temporal modulation similar to 3D confocal sensor 90. Like numbered elements supply the same functionality. Focus tunable lens 64 has been replaced by fixed lens 84 in 3D confocal sensor 92. Focus tunable lens 80 in FIG. 6 is placed at or near aperture stop 62. Focus tunable lens 80 may be, but is not limited to, a lens mechanically scanned by a voice coil or linear stage. Alternatively, focus tunable lens 80 may be a liquid lens where focus is adjusted by electrostatically changing the curvature of a liquid lens surface or by using sound waves to change the refractive index of focus tunable lens 80.

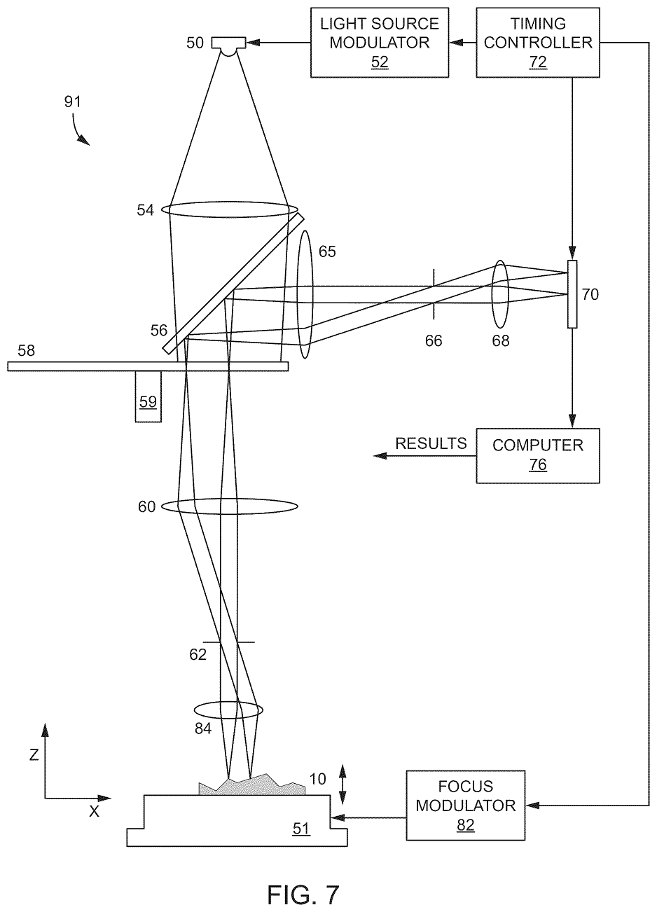

FIG. 7 is a diagrammatic view of an example 3D confocal sensor 91 with temporal modulation. Focus modulator 82 synchronously sweeps the position of object 10 through focus by moving stage assembly 51 in an axial direction of lens 84.

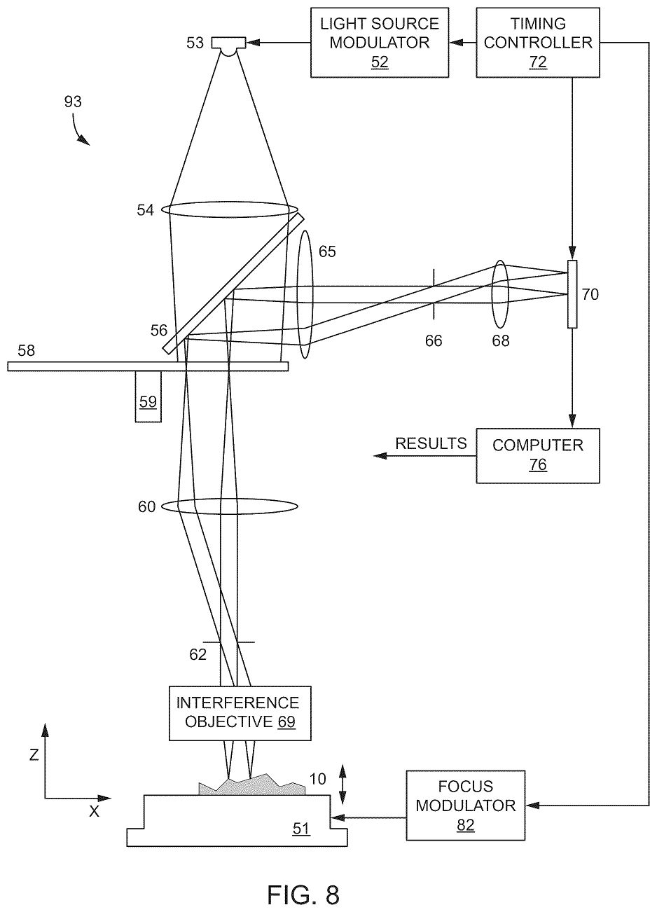

FIG. 8 is a diagrammatic view of an example 3D confocal sensor 93 with temporal modulation similar to 3D confocal sensor 91. Like numbered elements supply the same functionality. Fixed lens 84 has been replaced by interference objective 69 in 3D confocal sensor 93. Interference objective 69 may be, but is not limited to, known Mirau, Michelson, or Linnik type interferometer objectives. Light source 53 may be a short coherence length source or a long coherence length source. Light source 53 may be, but is not limited to, a LED, super-luminescent LED (SLED), laser, or incandescent source whereby the output intensity may be temporally modulated by light source modulator 52. Focus modulator 82 synchronously sweeps the position of object 10 through focus by moving stage assembly 51 in an axial direction of lens 84.

Individual pixels of camera detector 70 will receive a coherence interference signal during the focus sweep, due to interference objective 69, which is superimposed on the confocal response due to the pinhole apertures of Nipkow disk 58.

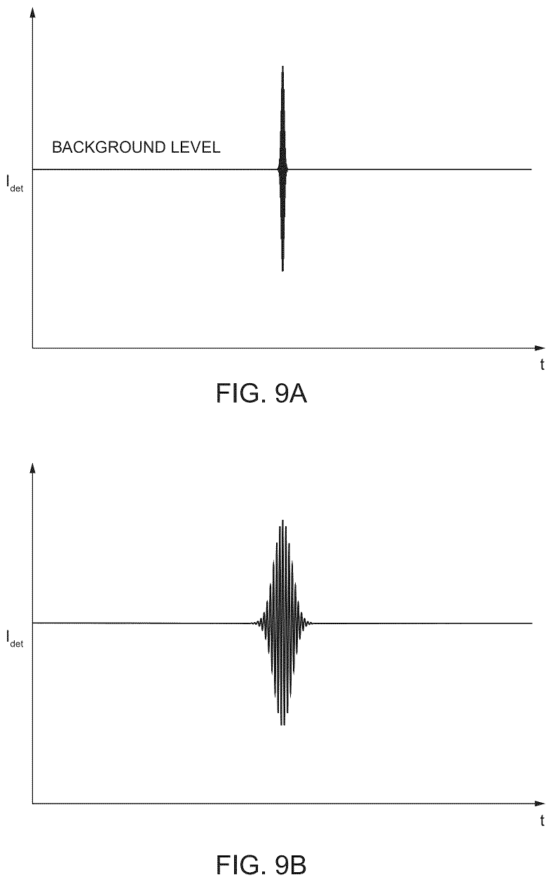

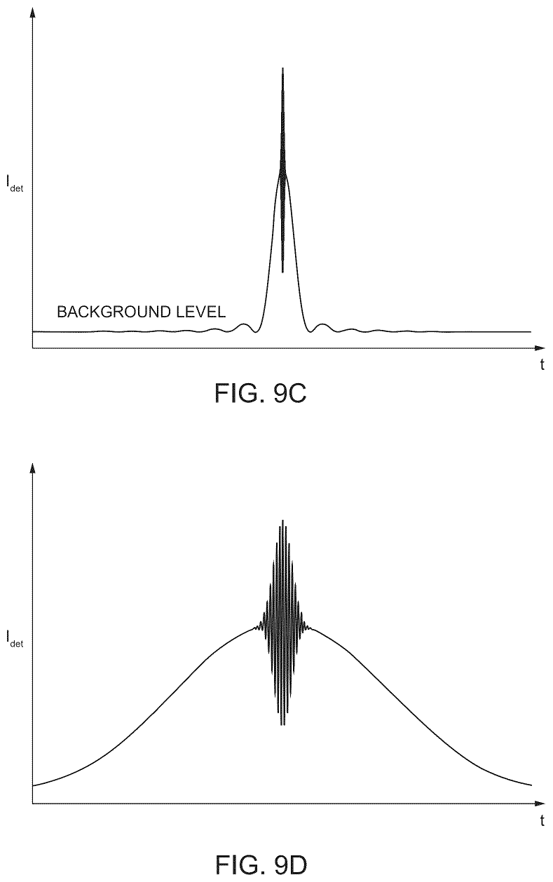

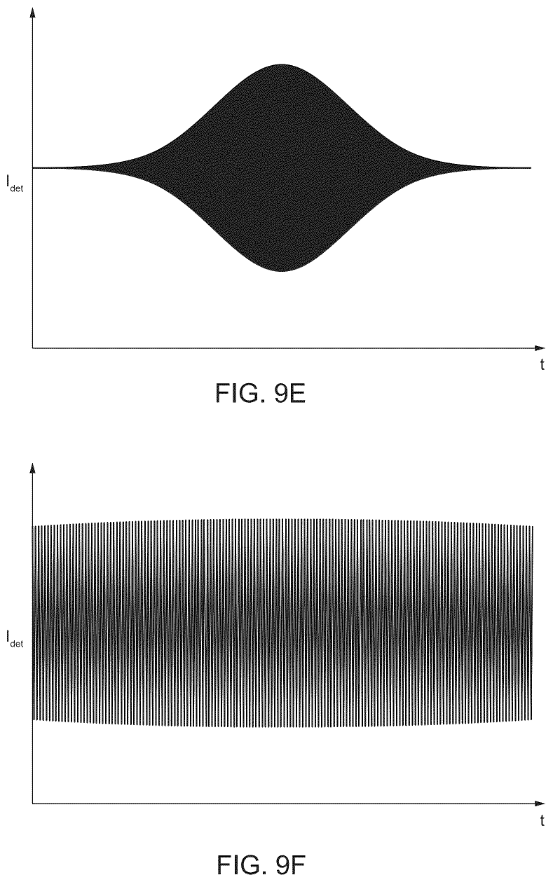

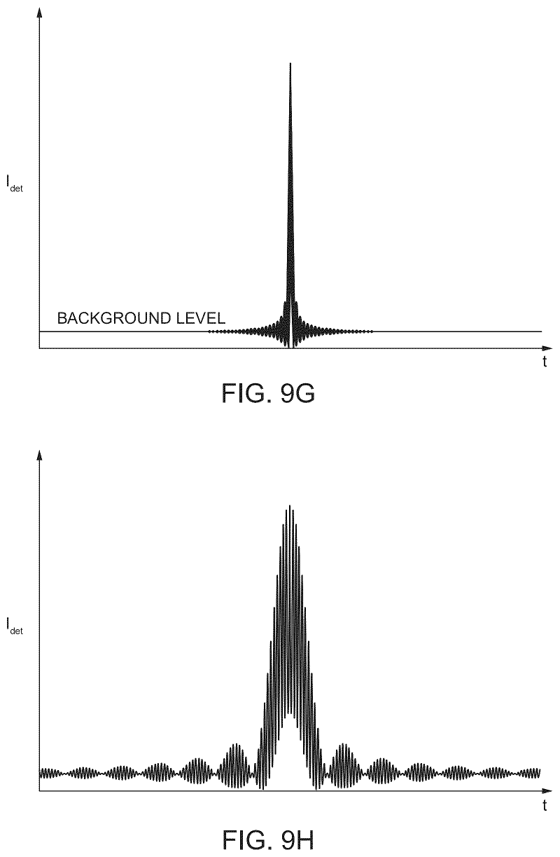

FIGS. 9A-D demonstrate a short coherence length source, such as an LED or incandescent source. FIG. 9A shows the interference pattern for a traditional interferometer, typically called a White Light Interferometer (WLI). FIG. 9B is a magnified portion of the scan showing the central portion of FIG. 9A. For a traditional WLI for most of the scan range there are no interference ripples, and for a very narrow height range defined by the coherence length of the source, a strong interference pattern, known as a correlogram, is visible. Away from best focus, the detector receives a high background level. For sensor 93, a characteristic pixel response, I_{det}, function is shown in FIG. 9C as a function of the focus position Z_{foc}. FIG. 9D is the same pixel response, I_{det}, as FIG. 9C over a smaller range focus position Z_{foc}. As can be seen in FIG. 9C, the background level away from best focus is much lower, due to the gating properties of the source and detection pinhole apertures, than in a traditional WLI response shown in FIG. 9A. This background level reduction allows the modulated return to be integrated onto a detector without adding excessive signal level or noise. Method 300 may be used to calculate height values of object 10 at each pixel location for 3D confocal sensor 93. As is described in method 300, several different light source modulation frequencies may be used while sweeping focus of object 10 with stage assembly 51. A minimum of two frequencies may be used to find the position of the modulation envelope and the position of the peak of the correlogram. For instance, a relatively low modulation frequency may be used to localize the confocal pinhole return and a high frequency used to find the peak position of the interference pattern.

FIG. 9E shows the response of a traditional interferometer when using a longer coherence length source (such as a multi-mode laser). FIG. 9F is a magnified portion of the scan showing the central portion of FIG. 9E. For a long coherence length source the interference fringes are visible over a very broad range but it is difficult to determine the peak location. This is the wrapping problem common to laser based interferometers. Using a long coherence length source with sensor 93 results in the return shown in FIG. 9G. FIG. 9H is a magnified portion of the scan showing the central portion of FIG. 9G. The sectioning properties of the pinhole confocal system confine the return to a small region near best focus. The peak of the correlogram is much more easily seen in the sensor 93 response (FIG. 9G) compared to a standard interferometer (FIG. 9F).

A common problem with scanning white light interferometers is the need for a large number of images, sampled at many focus height planes, particularly if there the height range is large. Method 300 applied to 3D confocal sensor 93 affords a method of overcoming this limitation. Be applying method 300 to find the position of the object 10 a first height estimate using low frequency temporal modulation pattern may be found in as few as two to three images. Low modulation frequencies are insensitive to the interference ripples near best focus, only the envelope is detected. This envelope detection is identical to the operating mode for sensor 90. Method 300 is then applied again with high frequency modulation pattern, where the modulation is only applied in a smaller focal sweep region near the first height estimate. Limiting illumination to a smaller scan region reduces scan time and reduces the integration of background light level and the shot noise associated with the integration of excess background level.

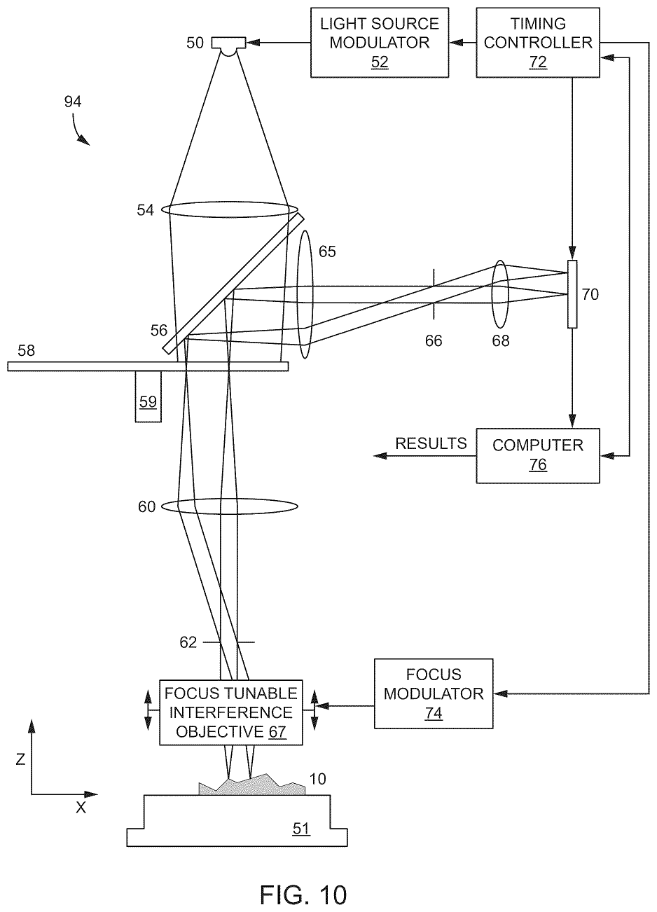

FIG. 10 is a diagrammatic view of an example 3D confocal sensor 94 with temporal modulation utilizing focus tunable interference objective 67. Focus tunable interference objective 67 may be, but is not limited to, an interference objective mechanically scanned by a voice coil or linear stage. Alternatively, focus tunable interference objective may include a liquid lens element or by using sound waves to change the refractive index of a lens element where focus is adjusted by either electrostatically changing the curvature of a liquid lens surface or by using sound waves to change the refractive index of a lens element focus tunable interference objective 67. Method 300 may be used to calculate height values of object 10 at each pixel location for 3D confocal sensor 94.

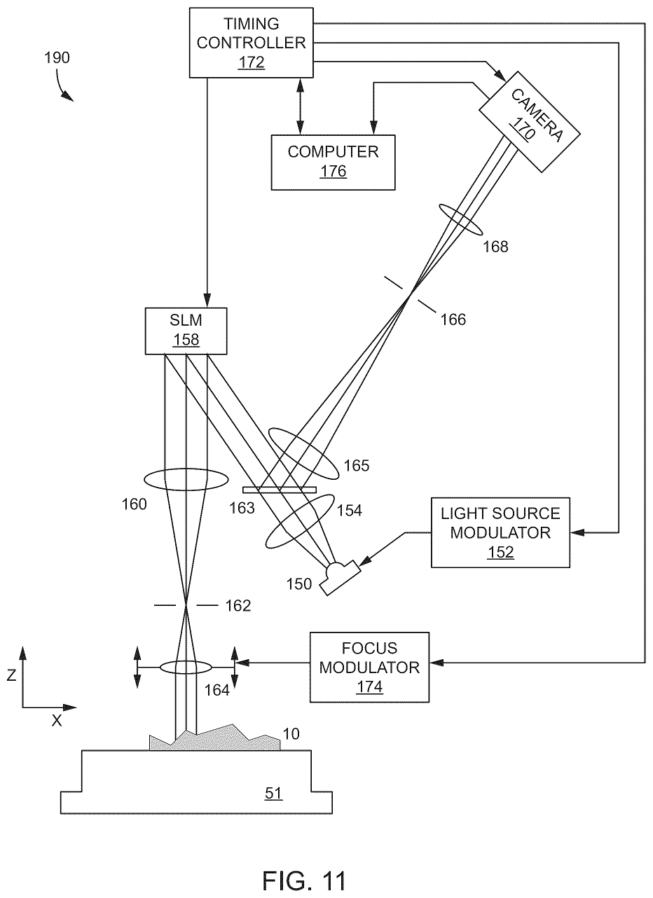

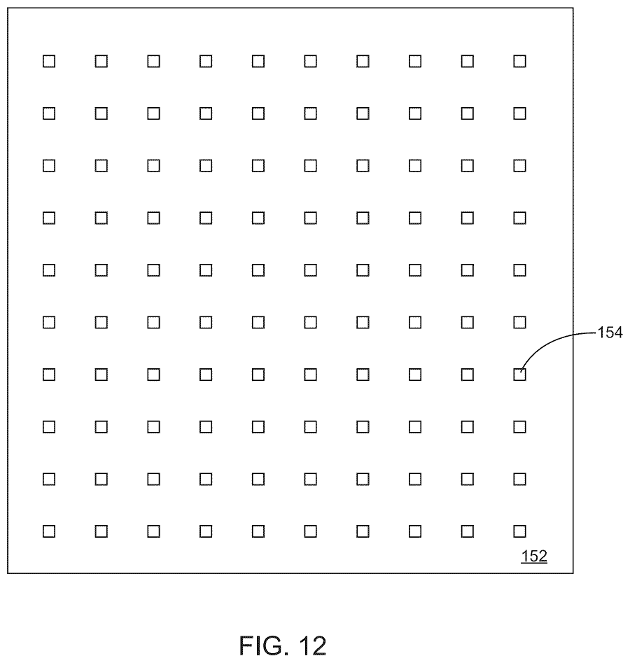

FIG. 11 is a diagrammatic view of an example 3D confocal sensor 190 with temporal modulation. 3D confocal sensor 190 operates under the same principle as 3D confocal sensor 90 with the functionality provided by Nipkow disk 58 replaced by spatial light modulator (SLM) 158. Both Nipkow disk 58 and spatial light modulator 158 reduce the background intensity away from best focus on camera 70 and camera 170 pixels, respectively, during a focal sweep when the measurement position of object 10 is away from best focus. Light from source 150 is modulated by light source modulator 152, collected by condenser lens 154, transmits through beam splitter 163, and is incident on spatial light modulator 158. Pixelated spatial light modulator 158 may be, but is not limited to, a digital mirror device (DMD) or liquid crystal on silicon device (LCOS). Light then reflects from actively on SLM 158 pixels. Lens 160, aperture stop 162 and focus tunable lens 164 create an imaging system to image SLM 158 pixels onto object 10. Light reflected from object 10 is imaged back onto SLM 158 by lens 164, aperture stop 162 and lens 160. Light then reflects off actively on SLM 158 pixels, reflects off beam splitter 163 and is then imaged onto camera 170 by the imaging system formed by lens 165, aperture stop 166 and lens 168. Spatial light modulator 158 may emulate the optical sectioning properties of a Nipkow disk system by utilizing a temporal series of spatial patterns similar to the spatial pattern of the Nipkow aperture array. An example SLM 158 spatial pattern is shown in FIG. 12. During a single focal sweep, the spatial patterns are temporally switched at high speed to effectively emulate the sweeping aperture array of a spinning Nipkow disk. Due to the optical sectioning properties of confocal microscopes, light reflected from actively on SLM 158 pixels will have a peak intensity when the point on the object is in best focus and the intensity will decrease rapidly away from best focus.

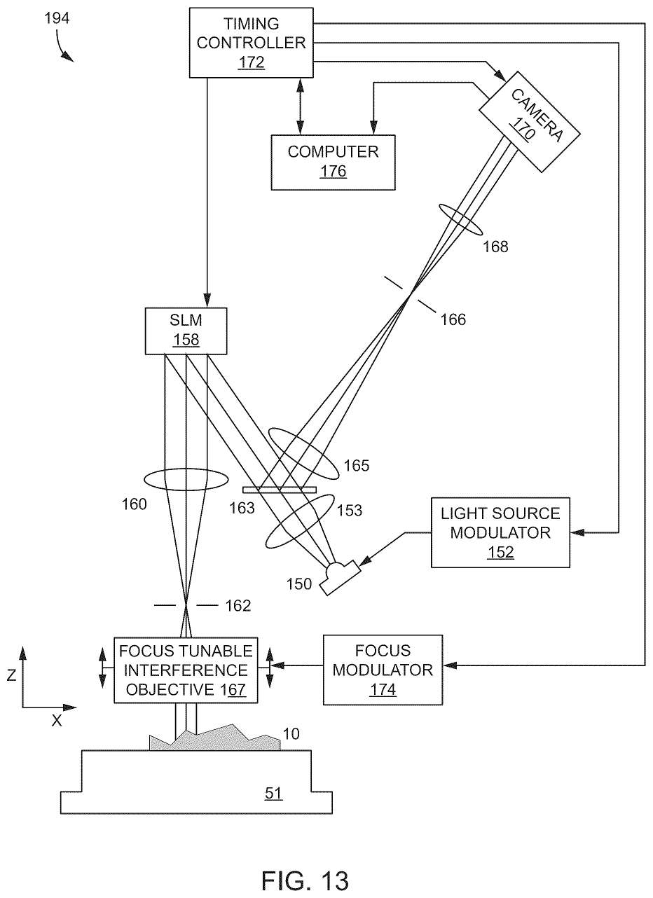

FIG. 13 is a diagrammatic view of an example 3D confocal sensor 194 with temporal modulation utilizing focus tunable interference objective 167. 3D confocal sensor 194 is similar to 3D confocal sensor 190 with focus tunable lens 164 replaced by focus tunable interference objective 167.

A common measurement task is the estimation of the thickness of a transparent layer, for example the thickness of a mask layer on the surface of a printed circuit board or the photoresist on a semiconductor wafer. For a single reflecting surface the 3D confocal sensor must estimate the surface reflectivity, height (phase of the returned signal), and contrast level of the returned signal. Including a second return results in five unknowns: object reflectivity, height of both surfaces, and contrast levels of both surfaces. At least five data points are needed to solve for these five unknowns.

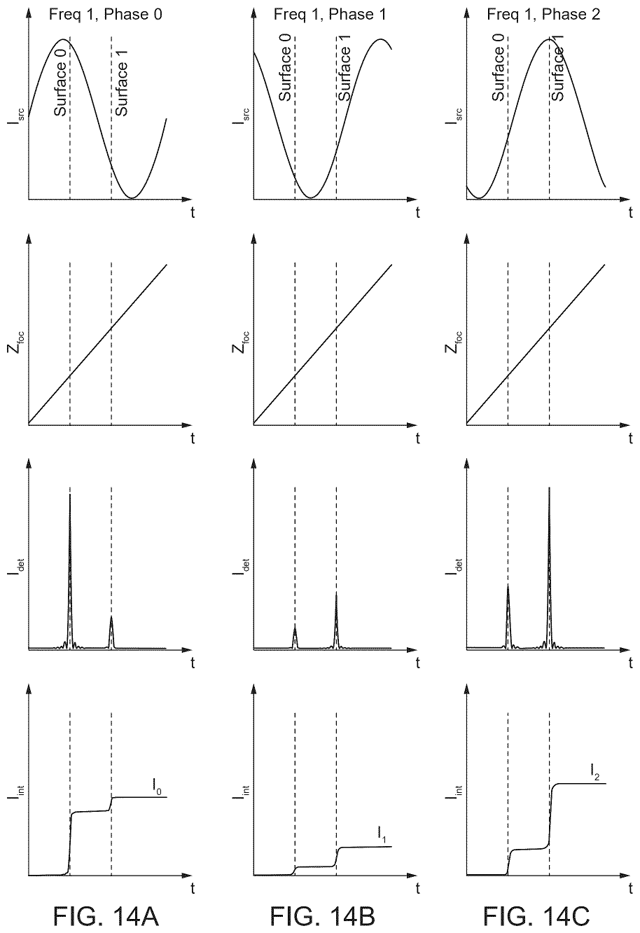

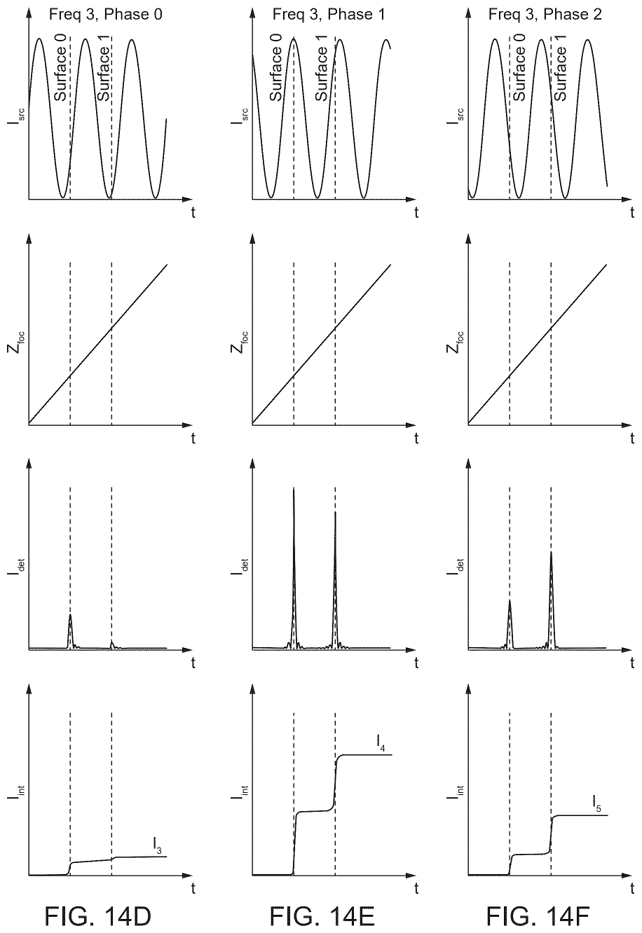

FIGS. 14A-14F show an example light source modulation phase and frequency pattern for measuring double return. In FIGS. 14A-14C, I_{src} is sinusoidally modulated at frequency fₖ=1 according to equation 1, where n=0, 1, 2. In FIGS. 14D-14F, I_{src} is sinusoidally modulated at frequency fₖ=3 according to equation 1, where n=0, 1, 2. For FIGS. 14A-14F the focus sweep is identical, the detected current I_{det} shows a double return. The timing of the two peak returns are marked by the dashed lines labeled ‘Surface 0’ and ‘Surface 1’. This double return is visible in the integrated signal Iᵢₙₜ. Integrated values I₀, I₁, I₂ correspond to measurements with frequency fₖ=1. Integrated values I₃, I₄, Is correspond to measurements with frequency fₖ=3. As described, there are five unknowns; using two modulation frequencies with three phases for each provides six measurements.

$${\hat{I}}_{k , n} = \frac{\hat{R}}{2} ( 1 + {\hat{C}}_{0} sin ( 2 π {f}_{k} {\hat{t}}_{0} + \frac{n 2 π}{3} ) + {\hat{C}}_{1} sin ( 2 π {f}_{k} {\hat{t}}_{1} + \frac{n 2 π}{3} ) ) \qquad Equation 7$$

object may be modeled by equation 7. The object reflectivity estimate is R, the returned contrast for each of the two surfaces are estimated as Ĉ₀ and Ĉ₁. Light sensed at the two focus positions is estimated as \hat{t}₀ and \hat{t}₁. Images of the object are collected at multiple phases n and frequencies fₖ. Once \hat{t}₀ and \hat{t}₁ have been estimated, these values may be converted to phase using Equation 10 and to height using the step 120 of method 300.

Since the integrated light level model includes trigonometric functions the most straightforward method estimating the object characteristics is an iterative least squares solver. A number of math libraries offer tools to minimize the fitting residual defined in equations such as Equation 8, for instance the Matlab® includes the function fminsearch. The process begins by defining the fitting residual in Equation 8.

$${r}_{k , n} = {I}_{k , n} - {\hat{I}}_{k , n} \qquad Equation 8$$

One approach is to minimize the sum of squared residuals, calculated as S in Equation 9.

$$S = \sum {r}_{k , n}^{2} = \sum {( {I}_{k , n} - {\hat{I}}_{k , n} )}^{2} \qquad Equation 9$$

Supplying this residual function along with initial parameter estimates to the iterative least squares solver results in best fit estimates of target reflectivity, phase, and contrast.

In practice, lens blurring will cause contrast C to decrease as modulation frequency f is increased. To achieve best results the C terms in Equation 7 should be weighted by this expected blurring with frequency. The fitting accuracy and robustness may be improved by including more frequencies in the image set.

As described above, temporal modulation is provided by modulating the light source. The same functionality can be achieved by temporally modulating sensitivity or transmission in other portions of the signal path. The gain of integrator 15 in sensor 22 or the integrator which is part of camera detector 70 and 170 may modulated temporally according to the same methods described to achieve the same performance. On-camera detector integrator modulation is used, for example, in Time Of Flight sensors such as the Texas Instruments OPT8241.

Alternatively, the gain of the optical path may be temporally modulated by the addition of a ferroelectric or liquid crystal light valve in the optical path. Other means of modulating the optical throughput include variable absorbers and crossed polarizers. Modulating the transparency or reflectance of a light valve may be used instead of temporally modulating light source 2, light source 50, or light source 53.

Alternatively in sensors 190 and 194. SLM 158 may temporally modulate the light by temporally modulating the throughput of the actively on SLM 158 pixels.

1. A single point confocal sensor for measuring height of a point on an object, the sensor comprising:
a light source;
a light source modulator configured to temporally modulate the light source intensity;
a source pinhole aperture positioned to be illuminated by the light source;
a focus-tunable lens configured to focus illumination passing through the source pinhole aperture onto the object;
a detector pinhole aperture configured to receive reflected light from the object, wherein the focus-tunable lens is configured to image the reflected light from the object onto the detector pinhole aperture;
a detector and an integrator configured to output a measurement indicative of total light transmitted through the detector pinhole aperture;
a processor operably coupled to the detector, integrator, and light source modulator, wherein the processor is configured to synchronously cause the light source modulator to modulate light source intensity while causing the focus tunable lens to sweep axial focal position.

2. The single point confocal sensor of claim 1, wherein the processor is further configured to calculate a height of the point on the object based on the output from the detector and integrator.

3. The single point confocal sensor of claim 2:
wherein during a first integration period, the processor is configured to control the light source modulator to modulate the light source at a first phase and first frequency while synchronously causing the focus-tunable lens to sweep axial focal position through a focus range, the processor being configured to read and store the integrator output for the first integration period and then reset the integrator;
wherein during a second integration period, the processor is configured to control the light source modulator to modulate the light source at a second phase and first frequency while synchronously causing the focus-tunable lens to sweep axial focal position through the focus range, the processor being configured to read and store the integrator output for the second integration period and then reset the integrator;
wherein during a third integration period, the processor is configured to control the light source modulator to modulate the light source at a third phase and first frequency while synchronously causing the focus-tunable lens to sweep axial focal position through the focus range, the processor being configured to read and store the integrator output for the third integration period; and
wherein the processor is configured to compute a phase of the light source corresponding to focus position based on the first, second, and third integrator outputs and to convert the phase of light source to a height of the point on the object.

4-7. (canceled)

8. The single point confocal sensor of claim 1, wherein the focus-tunable lens is mechanically scanned by a linear stage.

9. The single point confocal sensor of claim 1, wherein the focus-tunable lens is a liquid lens.

10. The single point confocal sensor of claim 9, wherein focus of the liquid focus-tunable lens is adjusted by electrostatically changing curvature of a liquid lens surface.

11. The single point confocal sensor of claim 1, wherein focus of the focus-tunable lens is adjusted by using sound waves to change the refractive index of the focus-tunable lens.

12. The single point confocal sensor of claim 1, wherein the temporal modulation is based on Gray codes.

13. The single point confocal sensor of claim 1, wherein the temporal modulation is based on ramps.

14. The single point confocal sensor of claim 1, wherein the temporal modulation is based on Hamiltonian codes.

15. The single point confocal sensor of claim 1, wherein the temporal light source modulation is a periodic function.

16. The single point confocal sensor of claim 15, wherein the periodic function is a sinusoidal function.

17. The single point confocal sensor of claim 15, wherein the periodic function has a period that is equal to an amount of time necessary for the focus-tunable lens to sweep axial focal position through the entire focus range.

18. A confocal three-dimensional sensor for measuring height of an array of points on an object, the sensor comprising:
a light source;
a light source modulator configured to temporally modulate light source intensity;
a pinhole aperture array configured to be illuminated by the light source and receive reflected light from the object;
a focus-tunable lens configured to focus illumination passing through the pinhole aperture array onto the object and image reflected light from the object onto the pinhole aperture array;
a focus modulator operably coupled to the focus-tunable lens, the focus modulator being configured to sweep axial focal position;
an imaging system to image the pinhole aperture array onto a camera detector;
a camera detector configured to receive reflected light from the object imaged onto the pinhole aperture array by the focus-tunable lens and to provide an output measurement indicative of total transmitted light through the pinhole aperture array for each point in the array of points;
a processor operably coupled to the camera detector, the processor being configured to synchronously cause the light source modulator to modulate light source intensity while causing the focus modulator to sweep axial focal position.

19. The confocal three-dimensional sensor of claim 18, wherein the processor is further configured to calculate a height of each point in the array of points based on the output from the camera detector.

20. The confocal three-dimensional sensor of claim 19, wherein the processor is configured:
during a first integration period, to cause the light source modulator to modulate the light source at a first phase and first frequency while synchronously causing the focus modulator to sweep axial focal position through a focus range, the processor being configured to read and store a video frame from the camera detector relative to the first integration period;
during a second integration period, to cause the light source modulator to modulate the light source at a second phase and first frequency while synchronously causing the focus modulator to sweep axial focal position through the focus range, the processor being configured to read and store a video frame from the camera detector relative to the second integration period;
during a third integration period, to cause the light source modulator to modulate the light source at a third phase and first frequency while synchronously causing the focus modulator to sweep axial focal position through the focus range, the processor being configured to read and store a video frame from the camera detector relative to the third integration period; and
to compute phase of the light source corresponding to focus position for video frame pixels based on the first, second, and third, stored video frames, and then convert the phase of the pixels to a height value.

21-37. (canceled)

38. The confocal three-dimensional sensor of claim 18, wherein the camera detector is a complementary metal-oxide semiconductor (CMOS) area array having a two-dimensional array of pixels.

39. The confocal three-dimensional sensor of claim 18, wherein the camera detector is a charge coupled device (CCD) area array having a two-dimensional array of pixels.

40. A confocal three-dimensional sensor for measuring height of an array of points on an object, the sensor comprising:
a light source;
a light source modulator configured to temporally modulate light source intensity;
a pinhole aperture array configured to be illuminated by the light source and receive reflected light from the object;
a focus modulator configured to sweep axial focal position;
an imaging system to image the pinhole aperture array onto a camera detector;
an interference objective configured to focus illumination passing through the pinhole aperture array onto the object and to provide a coherence interference signal onto the pinhole aperture array during a focus sweep;
a camera detector configured to receive the coherence interference signal transmitted through the pinhole aperture array and to provide an output measurement indicative of total transmitted light through the pinhole aperture array for each point in the array of points;
a processor operably coupled to the camera detector, the processor being configured to synchronously cause the light source modulator to modulate light source intensity while causing the focus modulator to sweep axial focal position.

41. The confocal three-dimensional sensor of claim 40, wherein the processor is further configured to calculate a height of each point in the array of points based on output from the camera detector.

42-119. (canceled)
